(19) United States
(12) Patent Application Publication
(10) Pub. No.: US 2014/0144136 A1
(43) Pub. Date: May 29, 2014

(54) SYSTEM AND METHOD FOR WASTE HEAT RECOVERY FOR INTERNAL COMBUSTION ENGINES

(71) Applicant: Spicer Off-Highway Belgium N.V., Oostkamp (BE)

(72) Inventor: Mark R.J. Versteyhe, Oostkamp (BE)

(21) Appl. No.: 14/091,439

(22) Filed: Nov. 27, 2013

Related U.S. Application Data
(60) Provisional application No. 61/730,645, filed on Nov. 28, 2012.

(51) Int. Cl. F02B 37/00

(52) U.S. Cl. CPC F02B 37/004
USPC 60/605.1

(57) ABSTRACT

A combined internal combustion engine and waste heat recovery system is provided. The combined internal combustion engine and waste heat recovery system comprises the internal combustion engine, the waste heat recovery system, and a ratio adapting device. The internal combustion engine includes a turbocharger. The waste heat recovery system comprises a condenser, a pump, a heat exchanger, and an expander. The expander is in driving engagement with the turbocharger. The ratio adapting device is drivingly engaged with an output of the internal combustion engine and the expander of the waste heat recovery system. The ratio adapting device may be engaged to transfer energy from at least one of the turbocharger and the expander to the output of the internal combustion engine.

### CLAIM OF PRIORITY

The present application claims the benefit of priority to U.S. Provisional Application No. 61/730,645 filed on Nov. 28, 2012, which is incorporated herein in its entirety by reference.

### FIELD OF THE INVENTION

The present invention relates to energy recovery systems and more specifically to waste heat recovery systems used with internal combustions engines.

### BACKGROUND OF THE INVENTION

A conventional internal combustion engine typically has a limited brake thermal efficiency (BTE). Energy released during a combustion process utilized by the internal combustion engine is only partially converted to useful work. A large portion of the energy released during the combustion process is rejected as waste heat to an ambient environment of the internal combustion engine. The waste heat is typically dispersed to the ambient environment of the internal combustion engine through the use of a cooling system and an exhaust system of the internal combustion engine. Efficiencies of the internal combustion alone (not accounting for any power transmission losses) typically do not exceed about 50%.

An amount of energy that is rejected as waste heat to the ambient environment is proportional to an efficiency, and thus a fuel consumption, of the internal combustion engine. With increasing fuel costs and emission regulations becoming more and more stringent, new technologies to improve an efficiency of internal combustion engines are highly sought after.

It would be advantageous to develop a waste heat recovery system for an internal combustion engine that increases an efficiency of the internal combustion engine and is compatible with existing internal combustion engine components.

### SUMMARY OF THE INVENTION

Presently provided by the invention, a driveshaft that may be formed using a hydroforming process, reduces a cost of the driveshaft, and has an increased critical speed, has surprisingly been discovered.

In one embodiment, the present invention is directed to a combined internal combustion engine and waste heat recovery system. The combined internal combustion engine and waste heat recovery system comprises the internal combustion engine, the waste heat recovery system, and a ratio adapting device. The internal combustion engine includes a turbocharger in fluid communication with a portion of the internal combustion engine through an intake and an exhaust of the internal combustion engine. The waste heat recovery system comprises a condenser, a pump in fluid communication with the condenser, a heat exchanger in fluid communication with the pump and thermal communication with the exhaust of the internal combustion engine, and an expander in fluid communication with the heat exchanger and the condenser. The expander is also in driving engagement with the turbocharger. The ratio adapting device is drivingly engaged with an output of the internal combustion engine and the expander of the waste heat recovery system. The ratio adapting device may be engaged to transfer energy from at least one of the turbocharger and the expander to the output of the internal combustion engine.

In another embodiment, the present invention is directed to a combined internal combustion engine and waste heat recovery system. The combined internal combustion engine and waste heat recovery system comprises the internal combustion engine, the waste heat recovery system, and a ratio adapting device. The internal combustion engine includes a turbocharger in fluid communication with a portion of the internal combustion engine through an intake and an exhaust of the internal combustion engine. The waste heat recovery system comprises a condenser, a pump in fluid communication with the condenser, a heat exchanger in fluid communication with the pump and thermal communication with the exhaust of the internal combustion engine, an expander in fluid communication with the heat exchanger and the condenser, the expander also in driving engagement with the turbocharger, and a regenerator in fluid communication with the condenser and the heat exchanger. The ratio adapting device is drivingly engaged with an output of the internal combustion engine and the expander of the waste heat recovery system. The ratio adapting device may be engaged to transfer energy from at least one of the turbocharger and the expander to the output of the internal combustion engine.

In another embodiment, the present invention is directed to a method for facilitating driving engagement between an internal combustion engine and waste heat recovery system. The method comprises the steps of providing the internal combustion engine including a turbocharger in fluid communication with a portion of the internal combustion engine through an intake and an exhaust of the internal combustion engine, providing the waste heat recovery system; providing a ratio adapting device drivingly engaged with an output of the internal combustion engine and the expander of the waste heat recovery system; vaporizing a working fluid using heat from exhaust gases of the internal combustion engine; driving the expander using the vaporized working fluid; and drivingly engaging the ratio adapting device to transfer energy from at least one of the turbocharger and the expander to the output of the internal combustion engine. The waste heat recovery system comprises a condenser, a pump in fluid communication with the condenser, a heat exchanger in fluid communication with the pump and thermal communication with the exhaust of the internal combustion engine, and an expander in fluid communication with the heat exchanger and the condenser, the expander also in driving engagement with the turbocharger.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a schematic illustration of a combined internal combustion engine and waste heat recovery system according to an embodiment of the present invention; and

FIG. 2 is a schematic illustration of a combined internal combustion engine and waste heat recovery system according to another embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

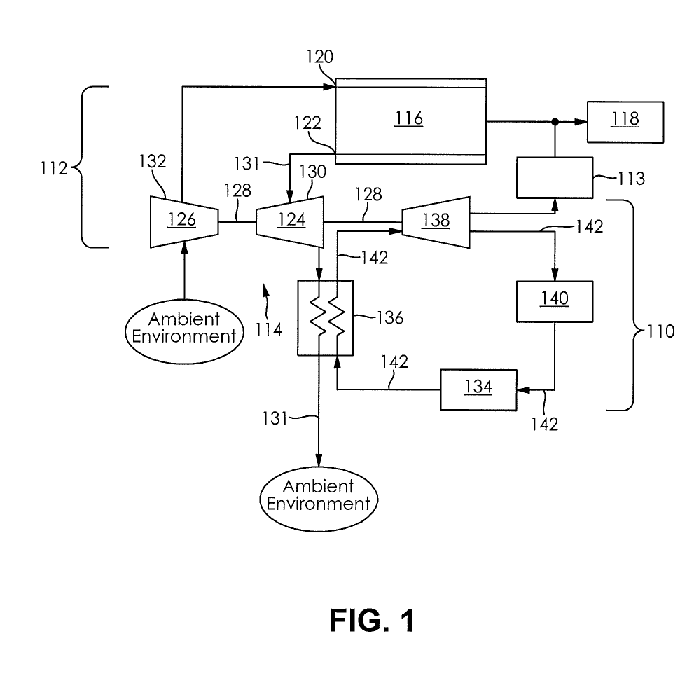

FIG. 1 schematically illustrates a waste heat recovery (WHR) system 110 for use with an internal combustion engine 112. The WHR system 110 is in driving engagement and fluid communication with the internal combustion engine 112. A portion of the WHR system 110 is in driving engagement with a portion of the internal combustion engine 112 through a ratio adapting device 113. The WHR system 110 may utilize the organic Rankine cycle; however, it is understood that other thermodynamic cycles may also be used with the WHR system 110. It is understood that the components of the WHR system 110, the components of the internal combustion engine 112, and a working fluid used with the WHR system 110 may be adapted for use with other thermodynamic cycles. The internal combustion engine 112 includes a turbocharger 114. Typically, the internal combustion engine 112 is used as a power source for a vehicle (not shown); however, it is understood that the internal combustion engine 112 may be used in other applications, such as in stationary power generation applications.

The internal combustion engine 112 comprises a primary portion 116, the turbocharger 114, and an engine output 118. The primary portion 116 is in fluid communication with the turbocharger 114 through an intake 120 and an exhaust 122 of the primary portion 116. The primary portion 116 is in driving engagement with the engine output 118. The internal combustion engine 112 may be any type of internal combustion engine which may be fitted with a turbocharger.

The primary portion 116 comprises at least an engine block; however, it is understood that the primary portion 116 may also include components typically used with an internal combustion engine, such as a plurality of valves, a plurality of pistons, at least one crankshaft, a plurality of connecting rods, a clutching device, a ratio adapting device, a fuel delivery system, an ignition system, and a cooling system.

The turbocharger 114 includes a turbine portion 124, a compressor portion 126, and a shaft 128. The turbine portion 124 and the compressor portion 126 are drivingly engaged with the shaft 128. As is known in the art, the turbine portion 124 is driven by exhaust gases via the exhaust 122. The turbine portion 124 is drivingly engaged with the compressor portion 126 to provide compressed air to the intake 120. The shaft 128 is also engaged with a portion of the WHR system 110; however, it is understood that the turbine portion 124 and the compressor portion 126 may be drivingly engaged with the portion of the WHR system 110 in another manner.

The turbine portion 124 comprises a plurality of blades (not shown) attached to a rotor (not shown) which is rotatingly disposed in a housing 130. The rotor is fixed to the shaft 128. During operation of the internal combustion engine 112, energy present in the exhaust gases leaving the exhaust 122 of the primary portion 116 is imparted to the plurality of blades, and thus to the rotor and the shaft 128. After exiting the turbine portion 124, the exhaust gases continue within an exhaust conduit 131 in fluid communication with the turbine portion 124.

The compressor portion 126 comprises an impeller (not shown) which is rotatingly disposed in a housing 132. The impeller is fixed to the shaft 128. During operation of the internal combustion engine 112, energy is imparted to air in the housing 132 through rotation of the impeller, which is driven by the shaft 128, thus increasing a pressure of air at the intake 120 of the primary portion 116.

The engine output 118 is a mechanical component driven by the primary portion 116. The engine output 118 may be a vehicle driveline or a portion of a vehicle driveline, such as a driveshaft, a transmission, or a flywheel. Alternately, it is understood that the engine output 118 may merely facilitate driving engagement between the primary portion 116 and a portion of an electric generator, for example.

The WHR system 110 comprises a pump 134, a heat exchanger 136, an expander 138, a condenser 140, and a plurality of fluid conduits 142. The pump 134 is in fluid communication with the heat exchanger 136 and the condenser 140. The expander 138 is in fluid communication with the condenser 140 and the heat exchanger 136. The WHR system 110 is a closed circuit, thermodynamic device that employs a liquid-vapor phase change to convert heat energy into motive power. It is understood that the WHR system 110 may include additional components not illustrated in FIG. 1, such as, but not limited to, a working fluid reservoir, a plurality of valves, and a plurality of sensors in communication with a control system. The plurality of fluid conduits 142 facilitate fluid communication to occur between each of the components 134, 136, 138, 140 and may comprise a plurality of preformed rigid tubes, flexible conduits, or conduits formed within a portion of each of the components 134, 136, 138, 140.

The pump 134 transfers the working fluid used with the WHR system 110 from the condenser 140 to the heat exchanger 136 through a portion of the plurality of fluid conduits 142. The pump 134 is conventional and well known in the art. The pump 134 may be an electrically operated pump designed to transfer the working fluid in a liquid state. Alternately, it is understood that the pump 134 may be mechanically driven by a rotating component of the primary portion 116, the turbocharger 114, or the expander 138.

The heat exchanger 136 facilitates thermal communication between the exhaust conduit 131 and a portion of the plurality of fluid conduits 142. It is understood that the heat exchanger 136 may comprise a plurality of heat exchangers. The heat exchanger 136 is conventional and well known in the art, and may also be referred to as an evaporator. As the working fluid passes through a portion of the heat exchanger 136, the working fluid is heated and evaporated by energy imparted to the working fluid by the exhaust gases passing through the exhaust conduit 131. As a result of the thermal communication between a portion of the plurality of fluid conduits 142 and the exhaust conduit 131, the working fluid leaves the heat exchanger 136 in a gaseous state.

The expander 138 extracts work from the working fluid in the gaseous state. The expander 138 is conventional and well known in the art, and may also be referred to as a turbine. The expander 138 comprises a plurality of blades (not shown) attached to a rotor (not shown) which is rotatingly disposed in a housing 130. The rotor is fixed to the shaft 128. The turbine portion 124, the compressor portion 126, and the expander 138 of are mounted on the shaft 128; however, it is understood that the portions of the turbocharger 114 and the expander 138 may be drivingly engaged with one another using at least one of a clutch (not shown) and a gear set (not shown). The expander 138 is drivingly engaged with the at least one crankshaft of the primary portion 116 through the ratio adapting device 113 to deliver additional work to the engine output 118.

During operation of the WHR system 110, the working fluid leaving the heat exchanger 136 is expanded in the expander 138, imparting work to the plurality of blades, and thus to the rotor and the shaft 128. During expansion of the working fluid, the working fluid drives the expander 138 and the pressure and temperature of the working fluid are reduced. After exiting the expander 138, the working fluid continues within a portion of the plurality of fluid conduits 142 to the condenser 140.

The condenser 140 facilitates thermal communication between the working fluid in the gaseous state and an ambient environment of the WHR system 110. The condenser 140 is a heat exchanging device and is conventional and well known in the art. The condenser 140 may be a liquid to air type heat exchanger or a liquid to liquid type heat exchanger. As the working fluid passes through a portion of the condenser 140, the working fluid is cooled as the energy within the working fluid is distributed by the condenser 140 to the ambient environment of the WHR system 110. The condenser 140 provides further cooling for the working fluid, an addition to the temperature drop that occurs as the working fluid passes through the expander 138. As a result of the thermal communication between the working fluid and the condenser 140, the working fluid condenses and leaves the condenser 140 in a liquid state. After passing through the condenser 140, the working fluid (now in a fully liquid state) flows to the working fluid reservoir (not shown) and is then pumped to an increased pressure by the pump 134 so that the cycle may be repeated.

The ratio adapting device 113 is a continuously variable transmission that is drivingly engaged with the shaft 128 and the at least one crankshaft of the primary portion 116. Alternately, it is understood that the ratio adapting device 113 may be drivingly engaged with the engine output 118. Further, it is understood that the ratio adapting device 113 may be drivingly engaged with a portion of the expander 138 or a portion of the turbocharger 114. The ratio adapting device 113 facilitates driving engagement between the shaft 128 and the engine output 118, despite a difference and a variability of a rotational speed of each of the shaft 128 and the engine output 118. The ratio adapting device 113 may include a clutching device (not shown) for drivingly disengaging the expander 138 from the at least one crankshaft of the primary portion 116 or the engine output 118. As a non-limiting example, the ratio adapting device 113 may be a pulley-belt style continuously variable transmission. The pulley-belt style continuously variable transmission comprises of a pair of variable-diameter pulleys, each shaped like a pair of opposing cones, with a belt running between them. The pulley-belt style continuously variable transmission is conventional and well known in the art. Alternately, the ratio adapting device 113 may comprise another type of ratio adapting device, such as a belted connection, a fixed ratio transmission, or a fixed ratio transmission paired with a slipping clutch, for example.

In use, the WHR system 110 paired with the internal combustion engine 112 increases an overall thermal efficiency of the internal combustion engine 112 and a vehicle the WHR system 110 and internal combustion engine 112 is incorporated in, and overcomes many problems common in internal combustion engines including traditional turbochargers. During operation of the WHR system 110, power applied by the ratio adapting device 113 to the at least one crankshaft increases an overall amount of power available to the vehicle and improves an efficiency of the vehicle incorporating the turbocharger 114 and the WHR system 110. The turbocharger 114 and the WHR system 110 allow the vehicle to include features and benefits of a vehicle including both a turbocharger and a waste heat recovery system, while overcoming problems common in conventional turbochargers.

The turbocharger 114 supplies air at an increased pressure to the primary portion 116 of the internal combustion engine 112. As a result, an increased amount of air is forced into a combustion chamber (not shown) of the primary portion 116, resulting in improved performance and fuel efficiency of the internal combustion engine 112. As mentioned hereinabove, the turbocharger 114 includes the turbine portion 124 and the compressor portion 126. The turbine portion 124 is driven by the exhaust gases leaving the exhaust 122 of the primary portion 116, which drives the compressor portion 126, and increases a pressure of the air entering the intake 120 of the primary portion 116. The internal combustion engine 112 incorporating the turbocharger 114 has a greater thermal efficiency than an internal combustion engine not incorporating a turbocharger.

The WHR system 110 captures a portion of a waste heat leaving the primary portion 116 present in the exhaust gases and converts the waste heat to useful work, increasing an overall thermal efficiency and a fuel efficiency of the internal combustion engine 112. The working fluid used with the WHR system 110 may be an organic fluid (which is used in both a liquid and a gaseous state, as described hereinabove). The working fluid is selected for a temperature range of the waste heat of the internal combustion engine 112. As non-limiting examples, the working fluid may be a refrigerant (such as R-22, R-123, R134a, or R245a), alcohol, butane, iso-butane, pentane, iso-pentane, hexane, iso-hexane, water, and any mixture thereof. Alternately, it is understood that the working fluid may be another type of fluid suitable for use in a waste heat recover system employing a thermodynamic cycle.

By drivingly engaging the turbocharger 114 and the expander 138 through the use of the shaft 128, the problem typically encountered of conventional turbochargers lacking power at low rotational speeds of an associated engine can be avoided. At low rotational speeds, conventional turbochargers produce an inadequate amount of boost pressure to quickly accelerate an associated turbine and compressor when a rapid acceleration of the engine is requested, which delays a throttle response of the vehicle. Such a dynamic is commonly known as “turbo lag.”

The WHR system 110 paired with the internal combustion engine 112 mechanically connects the turbocharger 114 and the expander 138 through the shaft 128, the turbine portion 124 of the turbocharger 114 can be kept at an optimal speed during periods of reduced boost pressure by being drivingly engaged with the expander 138 or the primary portion 116. The primary portion may be drivingly engaged with the turbine portion 124 through the ratio adapting device 113. By drivingly engaging the turbocharger 114 and the expander 138, the WHR system 110 paired with the internal combustion engine 112 can react quickly to a request for rapid acceleration. Further, an optimal speed of rotation of the turbocharger 114 may be maintained through driving engagement with the engine output 118 of the internal combustion engine 112 through the ratio adapting device 113. Conversely, at increased rotational speeds and loads of the internal combustion engine 112, the turbocharger 114 produces an excess amount of boost pressure.

Typically, such a problem is solved by including a wastegate in the conventional turbocharger. The wastegate is used to reduce the amount of boost pressure. The wastegate prevents a turbine of the conventional turbocharge from overspinning, which may result in damage. The wastegate bypasses a portion of the exhaust gases around the turbine to prevent overspinning. During operation of the wastegate, the overall thermal efficiency of the associate engine is reduced, as energy is not extracted from the portion of the exhaust gases bypassed around the turbine.

By drivingly engaging the turbocharger 114 and the expander 138 with the at least one crankshaft of the primary portion 116, the wastegate used in conventional turbochargers can be eliminated. If the boost pressure generated by the turbine portion 124 becomes excessive, and is capable of providing more work than required to drive the compressor portion 126, the excess energy of the turbine portion 124 can supplement the primary portion 116 by drivingly engaging the at least one crankshaft of the primary portion 116 through the ratio adapting device 113.

By using the WHR system 110 paired with the internal combustion engine 112, the thermal energy contained in the exhaust gases can be captured and converted to useful work, which may be applied to the at least one crankshaft of the primary portion as additional torque.

The ratio adapting device 113 may be drivingly engaged by either the turbocharger 114 (through the expander 138) or directly by the expander 138. Such an arrangement allows the ratio adapting device 113 to be used by both the turbocharger 114 and the expander 138, which eliminates a need for a separate transmission device for each.

Alternatively, it is understood that the shaft of the expander 138 may be drivingly engaged with a motor/generator. The motor/generator may be driven by the turbocharger 114 or the expander 138 to generate electrical energy. The electrical energy may be used to supply additional torque to the at least one crankshaft of the internal combustion engine 112 when the WHR system 110 is incorporated in a hybrid drive system or the electrical energy may be stored in a battery and used to power at least one auxiliary device.

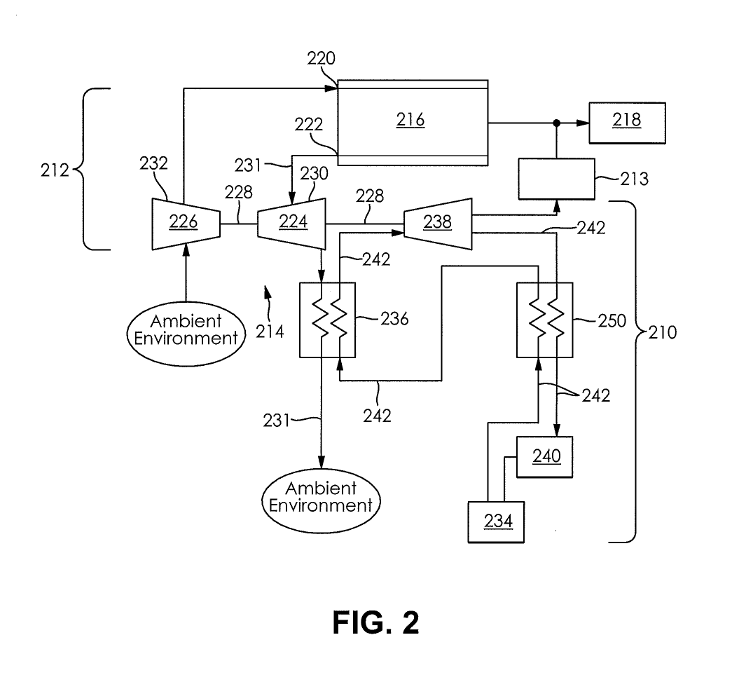

FIG. 2 schematically illustrates a waste heat recovery (WHR) system 210 for use with an internal combustion engine 212 according to another embodiment of the invention. The embodiment shown in FIG. 2 includes similar components to the waste heat recovery (WHR) system 110 for use with the internal combustion engine 112 illustrated in FIG. 1. Similar features of the embodiment shown in FIG. 2 are numbered similarly in series, with the exception of the features described below. The WHR system 210 is in driving engagement and fluid communication with the internal combustion engine 212. The internal combustion engine 212 includes a primary portion 216 and a turbocharger 214. The turbocharger 214 includes a turbine portion 224 and a compressor portion 226.

The WHR system 210 utilizes the organic Rankine cycle (ORC); however, it is understood that other thermodynamic cycles may also be used with the WHR system 210. As illustrated in FIG. 2, the WHR system includes a heat exchanger 236, an expander 238, a regenerator 250, a condenser 240, and a pump 234. A working fluid is circulated through the WHR system 210 using the pump 234.

The regenerator 250 is a heat exchanger which is used to preheat the working fluid exiting the pump 234, before the working fluid enters the heat exchanger 236. The regenerator 250 facilitates thermal communication between a portion of the fluid conduits 242 between the expander 238 and the condenser 240 and a portion of the plurality of fluid conduits 242 between the pump 234 and the heat exchanger 236. It is understood that the regenerator 250 may comprise a plurality of heat exchangers. As the working fluid passes through a portion of the regenerator 250, heat present in the working fluid within the portion of the fluid conduits 242 between the expander 238 and the condenser 240 is transferred to the working fluid within the portion of the plurality of fluid conduits 242 between the pump 234 and the heat exchanger 236. Typically, at least a portion of the working fluid remains in a superheated state following expansion in the expander 238, and a portion of the heat of the working fluid that in the superheated state after exiting the expander 238 can be recovered through use of the regenerator 250. The WHR system 210 incorporating the regenerator 250 improves a performance of the WHR system 210, which results in a higher amount of useful work being generated by the expander 238. The temperature of the working fluid leaving the expander 238 depends on the operating parameters and thermodynamic properties of the working fluid selected.

It is understood that any source of waste heat of the internal combustion engine 212 may form a portion of the WHR system 210. As non-limiting examples, the WHR system 210, in addition to the exhaust gases described above, may include an exhaust gas recirculation cooler (not shown), a charge air cooler (not shown), or an engine coolant circuit (not shown).

The WHR system 210 may include a plurality of heat exchangers to capture and combine the thermal energy of any number of waste heat sources. The more thermal energy recovered from the waste heat sources, the higher the overall thermal efficiency of the driveline become and the greater the reduction in fuel consumption of the ICE. Further, the higher the overall thermal efficiency of the driveline may allow a manufacturer of the vehicle to select an ICE of smaller size but of similar overall performance.

The driveline of the vehicle is drivingly engaged with the turbocharger 214 and the WHR system 210 by mechanically connecting a shaft 228 of the turbocharger 214 to a shaft of the expander 238. The WHR system 210 is also drivingly engaged with at least one crankshaft (not shown) of the internal combustion engine 212 through a ratio adapting device 213 such as a continuously variable transmission. The WHR system 210 overcomes some of the drawbacks typically encountered with conventional turbochargers, such as turbo lag and the necessity for a wastegate.

At low engine speeds the turbocharger 214 is kept at an optimal speed by being drivingly engaged with the expander 238. As a result, the driveline of the vehicle including the WHR system 210 can react quickly to a request for rapid acceleration. At high rotational speeds of the internal combustion engine 212 or when the driveline is under a heavy load, the turbine portion 224 provides more work than is required to drive the compressor portion 226. When the turbine portion 224 provides more work than is required, the excess energy of the turbine portion 224 may be used to supplement the internal combustion engine 212 by drivingly engaging the at least one crankshaft of the internal combustion engine 212 through the ratio adapting device 213. As a result, the turbocharger 214 does not need to include a wastegate for bypassing the exhaust gases past the turbine portion 224, which results in the turbocharger 214 having a greater efficiency.

The ratio adapting device 213 may be drivingly engaged by either the turbocharger 214 (through the expander 238) or directly by the expander 238. Such an arrangement allows the ratio adapting device 213 to be used by both the turbocharger 214 and the expander 238, which eliminates a need for a separate transmission device for each.

Alternatively, it is understood that the shaft of the expander 238 may be drivingly engaged with a motor/generator. The motor/generator may be driven by the turbocharger 214 or the expander 238 to generate electrical energy. The electrical energy may be used to supply additional torque to the at least one crankshaft of the internal combustion engine 212 when the WHR system 210 is incorporated in a hybrid drive system or the electrical energy may be stored in a battery and used to power at least one auxiliary device.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A combined internal combustion engine and waste heat recovery system, comprising:
the internal combustion engine including a turbocharger in fluid communication with a portion of the internal combustion engine through an intake and an exhaust of the internal combustion engine;
the waste heat recovery system, comprising:
a condenser;
a pump in fluid communication with the condenser;
a heat exchanger in fluid communication with the pump and thermal communication with the exhaust of the internal combustion engine; and
an expander in fluid communication with the heat exchanger and the condenser, the expander also in driving engagement with the turbocharger; and
a ratio adapting device drivingly engaged with an output of the internal combustion engine and the expander of the waste heat recovery system, wherein the ratio adapting device may be engaged to transfer energy from at least one of the turbocharger and the expander to the output of the internal combustion engine.

2. The combined internal combustion engine and waste heat recovery system according to claim 1, wherein the waste heat recovery system utilizes a fluid to perform a thermodynamic cycle.

3. The combined internal combustion engine and waste heat recovery system according to claim 2, wherein the fluid is a refrigerant.

4. The combined internal combustion engine and waste heat recovery system according to claim 2, wherein the thermodynamic cycle is the organic Rankine cycle.

5. The combined internal combustion engine and waste heat recovery system according to claim 1, wherein the expander is in driving engagement with a shaft portion of the turbocharger.

6. The combined internal combustion engine and waste heat recovery system according to claim 1, further comprising a regenerator, the regenerator in fluid communication with the condenser and the heat exchanger.

7. The combined internal combustion engine and waste heat recovery system according to claim 1, wherein the ratio adapting device is a continuously variable transmission.

8. The combined internal combustion engine and waste heat recovery system according to claim 1, wherein the ratio adapting device is a one of a belted connection and a fixed ratio transmission.

9. The combined internal combustion engine and waste heat recovery system according to claim 1, wherein the ratio adapting device is a fixed ratio transmission paired with a slipping clutch.

10. The combined internal combustion engine and waste heat recovery system according to claim 1, wherein the ratio adapting device is in driving engagement with a crankshaft of the internal combustion engine.

11. The combined internal combustion engine and waste heat recovery system according to claim 1, wherein an optimal speed of rotation of the turbocharger may be maintained through driving engagement with the output of the internal combustion engine through the ratio adapting device.

12. The combined internal combustion engine and waste heat recovery system according to claim 1, wherein an optimal speed of rotation of the turbocharger may be maintained through driving engagement with the expander of the waste heat recovery system.

13. The combined internal combustion engine and waste heat recovery system according to claim 1, wherein at high rotational speeds of the turbocharger, excess energy may be applied to the output of the internal combustion engine through the ratio adapting device.

14. A combined internal combustion engine and waste heat recovery system, comprising:
the internal combustion engine including a turbocharger in fluid communication with a portion of the internal combustion engine through an intake and an exhaust of the internal combustion engine;
the waste heat recovery system, comprising:
a condenser;
a pump in fluid communication with the condenser;
a heat exchanger in fluid communication with the pump and thermal communication with the exhaust of the internal combustion engine;
an expander in fluid communication with the heat exchanger and the condenser, the expander also in driving engagement with the turbocharger; and
a regenerator in fluid communication with the condenser and the heat exchanger; and
a ratio adapting device drivingly engaged with an output of the internal combustion engine and the expander of the waste heat recovery system, wherein the ratio adapting device may be engaged to transfer energy from at least one of the turbocharger and the expander to the output of the internal combustion engine.

15. The combined internal combustion engine and waste heat recovery system according to claim 14, wherein the waste heat recovery system utilizes the organic Rankine cycle.

16. The combined internal combustion engine and waste heat recovery system according to claim 14, wherein the expander is in driving engagement with a shaft, portion of the turbocharger.

17. The combined internal combustion engine and waste heat recovery system according to claim 14, wherein the ratio adapting device is a continuously variable transmission.

18. A method for facilitating driving engagement between an internal combustion engine and waste heat recovery system, comprising the steps of:
providing the internal combustion engine including a turbocharger in fluid communication with a portion of the internal combustion engine through an intake and an exhaust of the internal combustion engine;
providing the waste heat recovery system, comprising:
a condenser;
a pump in fluid communication with the condenser;
a heat exchanger in fluid communication with the pump and thermal communication with the exhaust of the internal combustion engine; and
an expander in fluid communication with the heat exchanger and the condenser, the expander also in driving engagement with the turbocharger; and
providing a ratio adapting device drivingly engaged with an output of the internal combustion engine and the expander of the waste heat recovery system;
vaporizing a working fluid using heat from exhaust gases of the internal combustion engine;
driving the expander using the vaporized working fluid; and
drivingly engaging the ratio adapting device to transfer energy from at least one of the turbocharger and the expander to the output of the internal combustion engine.

19. The method for facilitating driving engagement between an internal combustion engine and waste heat recovery system according to claim 19, further comprising the step of maintaining an optimal speed of rotation of the turbocharger through driving engagement with the output of the internal combustion engine through the ratio adapting device.

20. The method for facilitating driving engagement between an internal combustion engine and waste heat recovery system according to claim 9, further comprising the step of applying excess energy of the turbocharger at high rotational to the output of the internal combustion engine through the ratio adapting device.
